(19) United States
(12) Patent Application Publication
(10) Pub. No.: US 2017/0201098 A1
(43) Pub. Date: Jul. 13, 2017

(54) PHOTOVOLTAIC MICROSTORAGE MICROINVERTER

(71) Applicant: PV MICROSTORAGE, LLC, BRISTOL, VA (US)

(72) Inventor: P. KEVIN CARPENTER, SPRING, TX (US)

(21) Appl. No.: 14/991,275

(22) Filed: Jan. 8, 2016

(51) Int. Cl. H02J 3/38; H02J 7/35; H02M 7/44; H02J 7/00

(52) U.S. Cl. CPC H02J 3/383; H02J 7/0068; H02J 7/007; H02J 7/35; H02M 7/44

(57) ABSTRACT

A PV electrical system includes a PV panel, a MPPT controller, a charge controller coupled to a battery and an inverter generating alternating current output based on a first charge controller output disposed within the PV panel. The system further includes an AC bus receiving the alternating current output, whereby any number of PV panels are connected to the AC bus for providing power output. In varying embodiments, the connectivity of the components provides for charging and controlling output of the battery, as well as managing power distribution across the AC bus, on a per-panel basis.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to photovoltaic (PV) panels and more specifically to the inclusion of PV-panel-specific components for controlling distributed, scalable PV power generation and storage.

### BACKGROUND

Advancements in PV technology have been focused on harnessing power generated from the PV panels, overlooking techniques for fine-tuning the control and storage of distributed, scalable PV power.

For instance, common technologies for PV power provide for multiple PV panels connected in a series string and then a single string inverter unit controlling the output from all the PV panels on the string. This technique is extremely inefficient because of the variances in the power generation of all the PV panels and the inability for a string inverter to control the individual PV panels. For instance, different panels in the same string can be generating a wide variance of power due to dynamic shadowing, but using a string inverter thus inefficiently controls the PV power collection. Such multiple PV panel arrays, if equipped with energy storage, will have large batteries, which can also be cost prohibitive. Problems also arise in the scalability of these systems.

For instance, common technologies for PV power provide for multiple PV panels connected in a series string and then a single string inverter unit, which is connected to the service panel of a building, which is also connected to the grid. In these systems, the grid connection is necessary because no extant string inverter can power even a small building. In addition, these systems do not scale; it is difficult to add additional or more efficient PV panels to a string after the string inverter is installed.

Alternative PV power technologies provide for multiple PV panels, each connected to a microinverter, with all the microinverters connected in parallel to the service panel of a building, which is also connected to the grid. As this extant microinverter cannot operate without a grid connection, these systems are connected to the grid.

In addition, common technologies for off-grid or grid-down battery power provide for a battery bank connected to battery inverter, which is connected to a service sub-panel for a building. The battery bank must be charged by a separate battery charger, which is powered by the above PV string inverter. Such systems are very complex, requiring a battery charger, a PV inverter, a battery inverter, and a sub-panel. Extant battery inverters can power only moderate loads, thus requiring either a sub-panel in addition to the building service panel or that the building be very small. In addition, these extant microinverters cannot operate off-grid.

Some techniques have been developed to improve PV power collection and control, but those techniques continue to fail to address per-PV-panel granularity to maximize power collection, distribution, efficiency, storage, and scalability. For example, U.S. Pat. No. 9,136,732 (“Wolter”) illustrates the use of a master controller for controlling the PV panels, the master controller operates one or more integrated microinverter and energy storage (IMES) units. Wolter uses a bidirectional microinverter with an external master controller where the external master controller receives external input control commands to manage grid-connection of the PV panel assemblies. While Wolter provides the external master controller, this external master controller still operates a single control unit for multiple PV panels, thus failing to maximize per-PV-panel efficiency for both power generation and power storage/control.

Moreover, Wolter fails to provide utility for off-grid functionality. In addition Wolter fails to provide a charge controller component that is simplified and need not follow or support the input voltage of the MPPT controller component. Wolter further fails to provide a charge controller component that receives DC power from the MPPT controller component or an inverter component that receives DC power from the charge controller component. Wolter further does not provide an inverter component that is self-oscillating or an inverter component that is chosen to serve as the master oscillator for all other inverters in the string, Additionally, Wolter fails to describe operation or inverter oscillation at low load, such as would exist when the sun is shining, the batteries are fully charged, the system is off-grid, and few household appliances are on.

Another technique for controlling electricity generated from a PV panel is described in U.S. Published Application No. 2013/0264884 (“Kuo”), providing an inverter with a control unit within a PV cell module. Kuo notes the control unit can manage power flow for charging a battery when there is a difference between power generated by the PV panels and the power load recognized by the inverter. Kuo does not describe how to maximize power and fails to provide any clarity for its noted junction box. In addition, Kuo fails to illustrate a multiplicity of PV panels on a common bus, nor how those PV panels would distribute control or power.

Another technique is described in U.S. Published Application No. 2012/0104863 (“Yuan”), where the topology design minimizes voltage output and reduces installation concerns. Yuan uses a maximum power point tracking controller for the output of the PV panel, and constructs multiple PV panels in series instead of parallel interconnection. Additionally, Yuan describes controlling the flow of voltage off the PV panel, but does not account for any type of storage, therefore Yuan's system suffers significantly when sunlight is unavailable.

Kuo and Wolter both represent the state of the art where the power control units are connected to multiple PV panels. Moreover, Kuo and Wolter both fail to utilize or integrate scalable and distributed power control in the PV panel assemblies.

There exists a need for a PV system that provides scalable and distributed power control and storage on a per-PV-panel basis. Therefore, there exists a need for a PV system allowing for better control of the generated PV power, as well as reducing costs by providing per-PV-panel technology.

### BRIEF DESCRIPTION

Briefly, the present invention provides a PV electrical system including a PV panel, a maximum power point tracking (MPPT) controller, a charge controller coupled to a battery and an inverter generating alternating current (AC) output, all disposed within the PV panel. The system further includes a bus receiving the alternating current output, whereby one or more PV panels are connected to the bus for providing power output. The PV panel output is received directly by the MPPT controller. The charge controller receives the MPPT controller output, with optional engagement of the battery for storing or sourcing energy therefrom. The inverter receives the charge controller output and generates the alternating current output provided to the bus. The components provide for charging and controlling output of the battery, as well as controlling power distribution across the bus, on a per-PV-panel basis. The components taken together are also referred to as a photovoltaic microstorage microinverter (PVMM).

As such, the present PV panel system includes coordinated elements operating in a per-PV-panel set-up to improve and overcome the limitations and inefficiencies of the prior art.

### BRIEF DESCRIPTION OF THE DRAWINGS

FIG. 1 illustrates a block diagram of a PVMM;

FIG. 2 illustrates a flowchart of the processing operations of the PVMM of FIG. 1;

FIG. 3 illustrates a system of a plurality of PVMMs of FIG. 1 sharing a common bus;

FIG. 4 illustrates the system of FIG. 3 arranged in a first embodiment so as to function as an off-grid power system for a building;

FIG. 5 illustrates the system of FIG. 3 modified in a second embodiment so as to function as a grid-connected power system for a building or a local microgrid;

FIG. 6 illustrates the system of FIG. 3 modified in a third embodiment so as to function as a grid-connected utility-scale power system.

A better understanding of the disclosed technology will be obtained from the following detailed description of the embodiments taken in conjunction with the drawings and the attached claims.

### DETAILED DESCRIPTION

The present PV electric system overcomes the deficiencies of the prior art in providing a per-PV-panel solution for controlling and distributing PV power. The present PV system further improves system efficiency and control through the controller algorithms, scalability, and distributed energy storage.

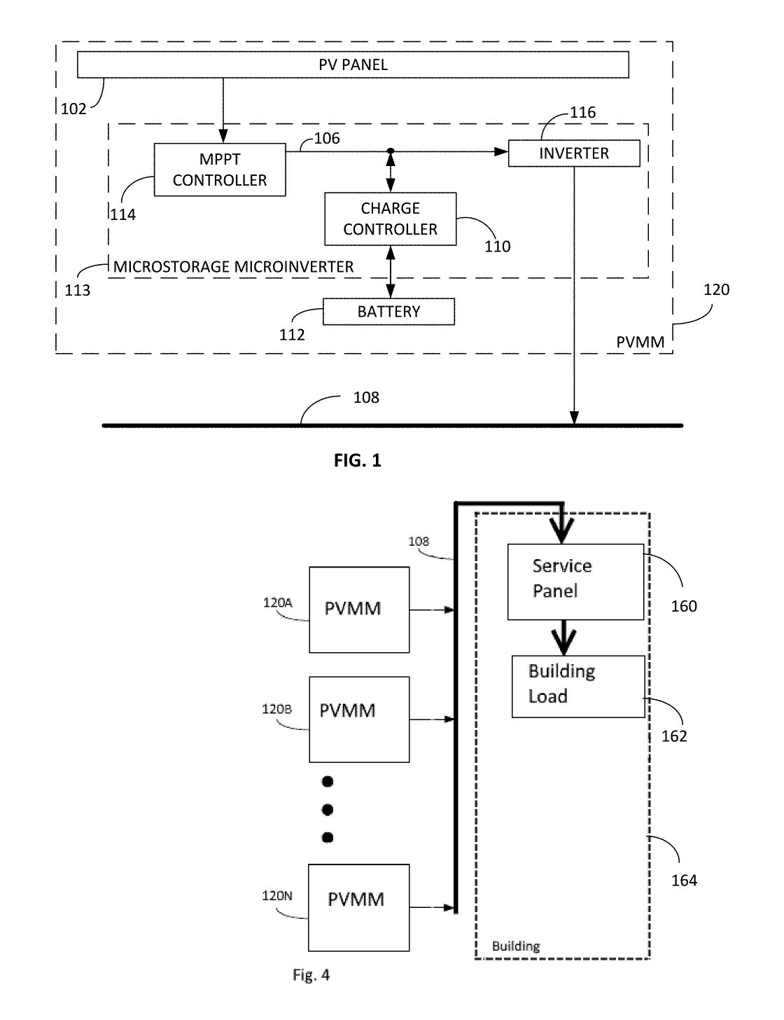

FIG. 1 illustrates the present invention of a PV electric system 120. The system of FIG. 1 includes the PV panel 102, the MPPT controller 114, the charge controller 110, the battery 112, the DC bus 106, and the inverter 116, as well as the AC bus 108. The system 120 is one embodiment of a photovoltaic microstorage microinverter (PVMM). Furthermore, as referred herein, the MPPT controller 114, the charge controller 110, the DC bus 106 and the inverter 116 collectively make up the microstorage microinverter 113.

It is recognized by one skilled in the art that further elements and connectivity means may be utilized and incorporated into the present system, whereby these means and connections are omitted for clarity purposes only.

The PV panel 102 transforms solar power into electrical power using known techniques. This PV panel 102 electrical power is low-voltage direct current (DC). The PV panel 102 may transform solar power into electrical power at a variety of efficiencies and output it at a variety of DC voltages.

The PV panel 102 may comprise a plurality of solar cells of varying types including but not limited to multi-crystalline silicon or single-crystal silicon or thin-film laminate or thin-film perovskite or an assembly of concentrating PV elements.

The PV panel 102 substrate may comprise a variety of types including but not limited to glass, metal, plastic, or roofing materials. In the latter case the solar cells are integrated into roofing shingles rather than separate solar panels.

The MPPT controller 114 receives the DC output power from the PV panel 102.

It is recognized that PV panels generate a varying amount of power based on environment conditions and shadowing, thus as the output power from the PV panel 102 varies, the MPPT controller 114 reacts to the PV operational changes. The MPPT controller 114 is capable of operating, when under moderate or high load, under known maximum power point tracking technology for instantly and at all times and under all operable conditions applying a proper input impedance for obtaining a maximum power for current environmental conditions and shadowing from its particular PV panel 102.

In addition it is recognized that buildings demand a varying amount of load based on the number and size of electrical devices operating on all the building circuits. The MPPT controller 114 is capable of operating, when under low or zero load, by applying increased input impedance for obtaining a low or zero power from its particular PV panel 102 that matches the low or zero load.

The MPPT controller 114 is coupled to both the charge controller 110 and the inverter 116 via the DC bus 106. The MPPT controller 114 pushes its output power to the DC bus 106. The charge controller 110 receives the incoming power from the DC bus 106. The charge controller 110 is coupled to the battery 112 and is connected to the inverter 116 via the DC bus 106. The inverter 116 is then connected to the AC bus 108 providing an alternating current (AC) to the AC bus 108.

The battery 112 may be any suitable type of rechargeable or secondary energy storage device, as recognized by one skilled in the art. The battery 112 is understood to comprise any number of cells and operate at a variety of DC voltages or currents. In addition the battery 112 may store a varying amount of maximum energy, depending on type or design. For example, the battery 112 may consist of one or more types to store the energy, wherein various factors may dictate the type or size of the battery, including space, costs, or number of overall PV panels in a connected system, by way of example. Suitable types may include but not be limited to a wide variety of lithium, lead, iron, nickel, molten metal, phase-change, thermal, or flow cell storage chemistries; capacitor, supercapacitor, or ultracapcitor electronic storage devices; flywheel or compressed gas electromechanical storage devices; or any number of energy storage devices not yet invented.

The charge controller 110 is bidirectional. It includes functionality for either receiving the incoming power from the DC bus 106 and charging the battery 112 or sensing load from inverter 116 and discharging the battery 112 to the DC bus 106. The charge controller 110 manages the power and energy input to battery 112. The charge controller 110 limits the DC current which is added to or drawn from the battery 110, preventing overcharging, over-voltage, or deep discharging of battery 110.

The inverter 116 may be any suitable inverter as recognized by one skilled in the art, operative to receive and processing the power from the DC bus 106. The inverter 116 is configured such that its AC output voltage, frequency and phase matches the desired AC power standard.

In several exemplary embodiments, the inverter 116 AC output may supply 220 VAC for USA buildings, 240 VAC for European buildings, 220 VAC 50 Hz for Japan buildings and 4 kVAC 3-phase for grid utilities. As recognized by one skilled in the art, any suitable inverter output may be generated based on load conditions or any other requirements, whereby the above exemplary embodiments are exemplary in nature and not limiting of the inverter outputs.

The MPPT controller 114, charge controller 110, DC bus 106, and inverter 116 together comprise a microstorage microinverter 113 which is generally disposed in a unitary enclosure for convenient installation. The battery 110 is generally disposed in its own separate enclosure to facilitate servicing.

The AC bus 108 may be any suitable type of AC bus operative to connect the PVMM 120 in parallel connection. For example, the AC bus 108 may operate at a maximum 60 amps to carry the alternating current. The AC bus 108 may be further connected to additional power consumption or power delivery elements, such as connected to a power grid, generator, service box, house, building, or business, etc.

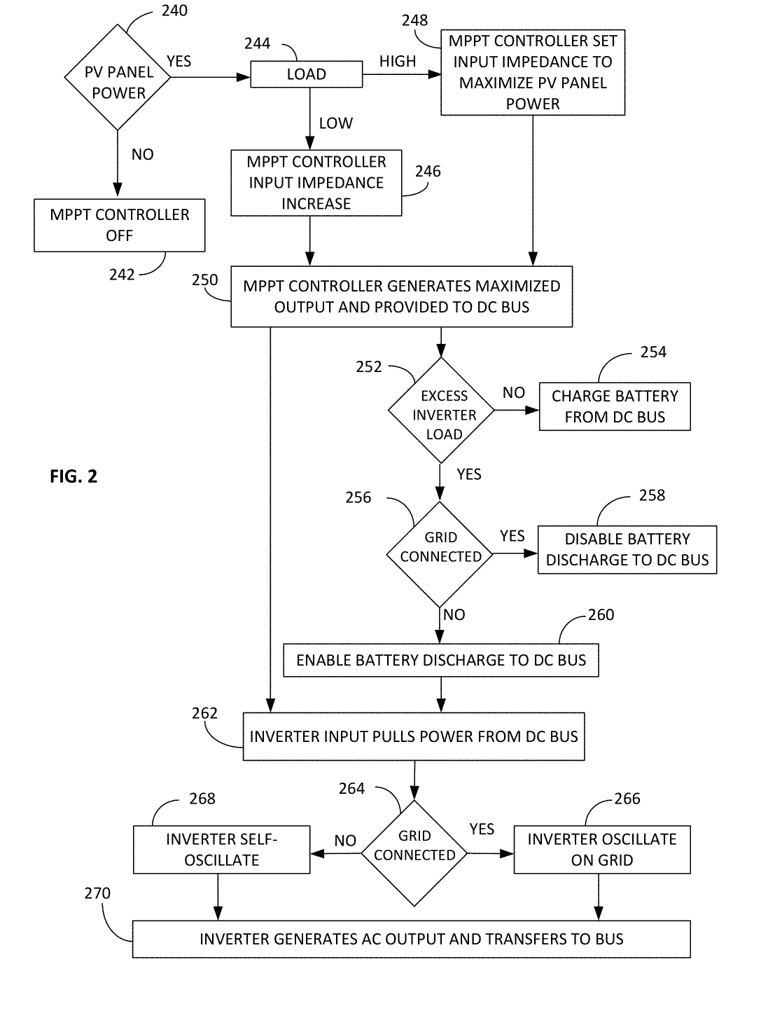

FIG. 2 illustrates a flowchart of one embodiment of operational steps in the system of FIG. 1. In the system of FIG. 1, the MPPT controller 114, charge controller 110, and inverter 116 which together comprise a microstorage microinverter 113, each have inputs and outputs under active, instantaneous, embedded, distributed control. The microstorage microinverter 113 may be enabled for off-grid operation or grid-connected operation by switch or software or factory configuration, enabling charge controller 110 and inverter 116 to discriminate the presence of a grid connection, which alters the operation of each. The microstorage microinverter 113 may be enabled as a master oscillator or not by switch or software or factory configuration, which alters the operation of inverter 116.

In the flowchart of FIG. 2, the first step, step 240, is to determine if the PV panel generates PV power. If no, the MPPT controller turns off, step 242.

If yes, the MPPT controller proceeds to step 244. The MPPT controller DC output power is loaded by the sum of loads from the charge controller and the inverter. If there is low or zero load, the MPPT controller increases its input impedance to match the PV panel power to the load, step 246. If there is high load the MPPT controller sets its input impedance to maximize PV panel power, step 248.

The MPPT controller constantly re-iterates steps 240, 244, 246, and 248. The MPPT controller receives the PV panel DC output power, step 250.

The MPPT controller processes the PV panel output power such that the charge controller and the inverter receive the MPPT controller DC output power, step 250, via the DC bus 106 of FIG. 1.

The charge controller, in step 252, operates to determine if there is load from the inverter that exceeds the instantaneous output power of the MPPT controller. If no, the charge controller proceeds to step 254, charging the battery from the DC bus.

When the inquiry of step 252 answers in the affirmative, the charge controller proceeds to step 256, determining if a grid connection is present. If yes, step 258 is to disable battery discharge to the DC bus. If a grid connection is not present, step 260 is to enable the battery discharge to the DC bus. The charge controller constantly re-iterates steps 252, 254, 256 and 258. The next step, step 262, the inverter pulls the power from the DC bus, based on the charge controller, from the battery (step 260) or from the MPPT controller (step 250).

In one embodiment, the inverter determines if the system is grid connected, step 264. If so, the inverter oscillates in phase with the grid, step 266. If not and the inverter is the master oscillator, it self-oscillates, step 268. If the grid connection is not present and the inverter is not the master oscillator, the inverter oscillates in phase with the master oscillator, also step 268. Wherein, in step 270, the inverter generates AC output and transfers this to the AC bus.

Therefore, the present PV system improves upon the prior art by providing a per-panel system, including a storage component therein. The interconnection along a common AC bus allows for shared distribution of power, as well as allowing plug-and-play with varying PV panel components. Additionally, the varying component structures allow for improved management of the power collection and distribution, as well as managing non-PV power generating events and grid-disconnect.

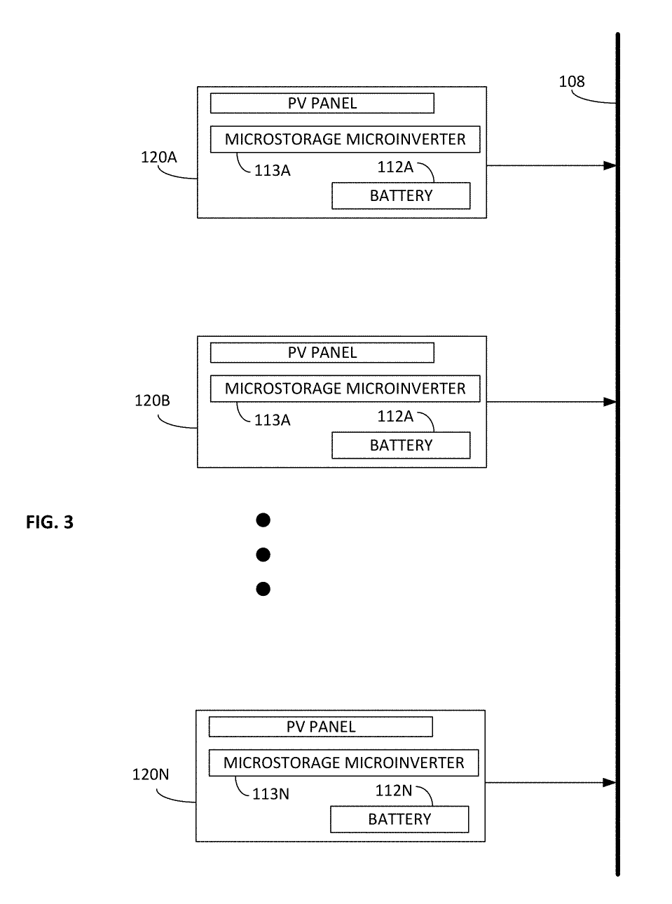

FIG. 3 illustrates a scalable plurality of PVMMs 120 connected in parallel on AC bus 108. As the system 100 can be operational on a per-PV-panel basis and multiple PVMMs 120 sharing the AC bus 108, the system 100 is further scalable. Scalability can be determined by multiple factors, including costs, available space, load, etc. Wherein, the present system using multiple PVMMs in parallel, rather than in series, allows for the AC voltage on AC bus 108 to remain low.

In this system, a first PVMM 120A includes a PV panel 102A, microstorage microinverter 113A and battery 112A. The elements 102A, 113A and 112A operate in a manner as described above.

FIG. 3 further illustrates a second PVMM 120B, with a second PV panel 102B, microstorage microinverter 113B and battery 112B. This second PVMM 120B is further coupled to the AC bus 108 in parallel with the first PVMM 120A.

An “n” numbered PVMM 120N further includes the PV panel 102N, microstorage microinverter 113N and battery 112N. Here, N represents any suitable integer, such that as illustrated the parallel connections may include any suitable number of parallel-connected PVMMs 120 with PV panels 102, microstorage microinverters 113 and batteries 112.

As such, illustrated in FIG. 3, the per-PV-panel system of operational components with the panel 150 allows for benefits as described herein. The system of FIG. 3 includes scalability by allowing for any suitable number of PVMMs to be simply plugged into the AC bus. Furthermore, the use of the shared AC bus allows for any different variety of per-PV-panel elements, including different types or models of PV panels, batteries, inventors, etc., such that the overall multiple PVMM array can be a plug-and-play system.

While the embodiment of FIG. 3 illustrates the PVMM 120, which includes PV panel 102, microstorage microinverter 113 and battery 112, it is noted that this is not limiting in nature. Rather, the PVMM 120 generally includes the elements of the PV panel 102, the elements of the microstorage microinverter 113 and elements of the battery 112 of FIG. 1. Therefore, the PVMM 120 may include the elements of the embodiment of FIG. 1 operating in parallel using the AC bus 108 and the disclosure of FIG. 3 is not expressly limited to the per-PV-panel system of FIG. 1. Rather, the PVMM 120 can operate as noted in the system of FIG. 1 above.

Where there is a high AC power load per-PVMM 120, the system of FIG. 1 can therein upgrade the battery 112, charge controller 110, and inverter 116 to handle the load, while using the same PV panel 102 and without increasing the total number of PVMMs 120 on AC bus 108. This enables an array comprising a small number of PVMMs 120, such as might be required on a building with limited rooftop or land space, to handle higher transient loads than if the array comprised only PV panels.

Optionally, where there is a high AC power load on the AC bus 108, the combination of multiple PVMMs 120 via the common AC bus, illustrated in FIG. 3, also allows for the high AC power consumption without modification of the PV panel(s) 102 or PVMM(s) 120.

FIG. 4 illustrates a preferred embodiment of a system 100 wherein the scalable plurality of PVMMs 120 connected on AC bus 108, as illustrated in FIG. 3, is connected to and powers a service panel 160 which in turn powers a building load 162 in an off-grid building 164. The service panel is not grid-connected in this embodiment.

In the system of FIG. 4 the battery storage allows for powering the building 164 by PV power in sunny conditions and to power the building 164 by battery storage in dark conditions.

In the system of FIG. 4 the grid connection discrimination function of each of the scalable plurality of PVMMs 120 is switched off and one of the scalable plurality of PVMMs 120 is chosen as a master oscillator.

The scalable plurality of PVMMs 120 may be arrayed on the roof of the building, on adjacent land, or anywhere nearby that is convenient or any combination thereof.

Each PVMM 120 includes an inverter 116, which is configured such that its AC output voltage and frequency matches the AC power standard of the building.

The system of FIG. 4 is further enabled for off-grid operations because for low-load operations, where the sun is shining, the batteries are charged, and the load is low, MPPT controller 114 is enabled to increase its input impedance and thus lower the DC current drawn from PV panel 102. MPPT controller 114 is further enabled to operate at far below the current of the maximum power point of PV panel 102. MPPT controller 114 is further enabled to increase its input impedance effectively to infinity and thus disconnect from PV panel 102.

The system of FIG. 4 is further enabled for off-grid operations because grid connection for the inverter 116 is optional. In this embodiment, the inverter 116 may be fully islanded and does not require a grid signal to activate AC power inversion. In this embodiment, the inverter 116 can be activated by switch or software or factory configuration causing it to self-oscillate at the required AC frequency.

The system of FIG. 4 further operates in a per-PV-panel embodiment and allows for interconnection of multiple PVMMs in parallel operation via the AC bus 108. In this embodiment, with multiple PVMMs 120, each PVMM having its own inverter 116, one inverter 116 can be chosen by switch or software or factory configuration as the master oscillator, causing it to self-oscillate at the required AC frequency, and all other inverters 116 can therein auto-synch to oscillate in phase with the master oscillator.

The system of FIG. 4 is further enabled for off-grid operations because for low-load operations, where there is minimal power consumption, each PVMM 120 then operates in a low-load condition. Here, the inverter 116 within each PVMM 120 is enabled to oscillate at system AC voltage, allowing minimal loads, such as clocks, to continue to operate.

The off-grid functionality of the preferred embodiment illustrated in FIG. 4 is a natural consequence of the operational steps illustrated in FIG. 2 and does not require any modification thereof.

In one exemplary embodiment, the battery within the PVMM 120 may be a lithium-iron-phosphate rechargeable battery. This exemplary battery has a storage capacity of 100 Ah per cell with a voltage of 3.2 VDC per cell and an approximate weight of 3.2 kilograms per cell at a cost of $170 per cell. In this example, it is under $350 to include 640 Wh in a single PVMM 120 including 2 lithium-iron-phosphate cells. The 2 cells would have a volume of 4100 cm3. In the example, the PVMM 120 easily charges its own battery over the course of a sunny day. Multiple PVMMs 120, connected via the AC bus 108, can thus power an off-grid house, building, or other power-consuming unit 164, during the night.

It is noted, the above example is illustrative in nature and not expressly limiting. The varying types of batteries, number of PVMMs in parallel connection, as well as costs, size and weight allow for numerous system configurations.

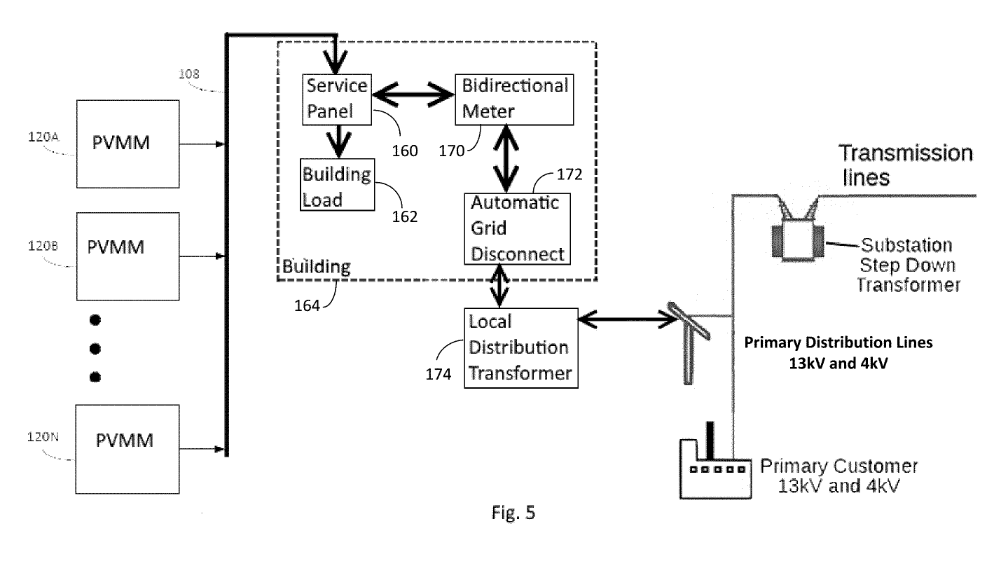

FIG. 5 illustrates a preferred embodiment wherein the scalable plurality of PVMMs 120 connected on AC bus 108, as illustrated in FIG. 3, is connected to and powers a service panel 160 which in turn powers a building load 162 in a grid-connected building 164. The service panel 160 is grid-connected through a bidirectional meter 170 and an automatic grid disconnect 172 in this embodiment. This grid connection supplies a grid signal to inverters in the PVMMs 120 and causes inverters to oscillate in phase with the grid.

The system of FIG. 5 provides battery storage enabling powering the building 164 in sunny conditions, bridge the building 164 through grid-down events, but not to power the building 164 in dark conditions.

In the system of FIG. 5 the grid connection discrimination function of each of the scalable plurality of PVMM 120s is switched on and one of the scalable plurality of PVMMs 120 is chosen as a master oscillator.

The scalable plurality of PVMMs 120 may be arrayed on the roof of the building, on adjacent land, or anywhere nearby that is convenient or any combination thereof.

Each PVMM 120 includes an inverter, which is configured such that its AC output voltage and frequency matches the AC power standard of the building 164 and the grid.

In one embodiment, each PVMM 120 operates as per the flowchart of FIG. 2 in which the charge controller 110 balances battery charging and discharging against the power from the PV panel 102 and the load.

The grid is low-impedance, enabling it to receive all the excess power generated by the scalable plurality of PVMMs 120 in sunny conditions and running the bidirectional meter 170 backward.

As a further consequence of the low impedance of the grid, the grid presents a load to the scalable plurality of PVMMs 120. The scalable plurality of PVMMs 120 does not and need not differentiate between the building load 162 and the grid load.

The system of FIG. 5 includes an automatic grid disconnect 172 between the bidirectional meter and the grid. Whereby, if there is a grid-down event, the PVMMs 120 can therein respond instantly to the grid-down event and provide power. Thus, the PVMMs 120 allow for avoiding power drop-outs such that the system 100 comprises a building-scale uninterruptible power supply.

The system of FIG. 5 is further enabled for grid-connected operations by the grid connection discrimination function of the charge controller 110 and the inverter 116 as per the flowchart of FIG. 2. During a grid-down event the grid connection is lost, the automatic grid disconnect 172 disconnects from the AC bus 108, the charge controller 110 enables discharge of the battery 112 to the inverter 116 via the DC bus 106 (as noted in FIG. 1), the PVMM 120 chosen as the master oscillator begins to self-oscillate, all the other PVMMs 120 in the scalable plurality of PVMMs 120 begin to oscillate in synch with the master oscillator, and power to the building service panel 160 is restored.

The system of FIG. 5 is further enabled for grid-connected operations by the grid connection discrimination function of the charge controller 110 as per the flowchart of FIG. 2. In dark conditions, when PV power is not available, and the grid connection is present, the charge controller 110 disables discharge of the battery 112 to the DC bus 108, as noted in FIG. 1. Thus the charge of the battery is conserved, even over the duration of a night, and held ready to bridge the building 164 through grid-down events.

The grid-connected functionality of the preferred embodiment illustrated in FIG. 5 is a natural consequence of the operational steps illustrated in FIG. 2 and does not require any modification thereof.

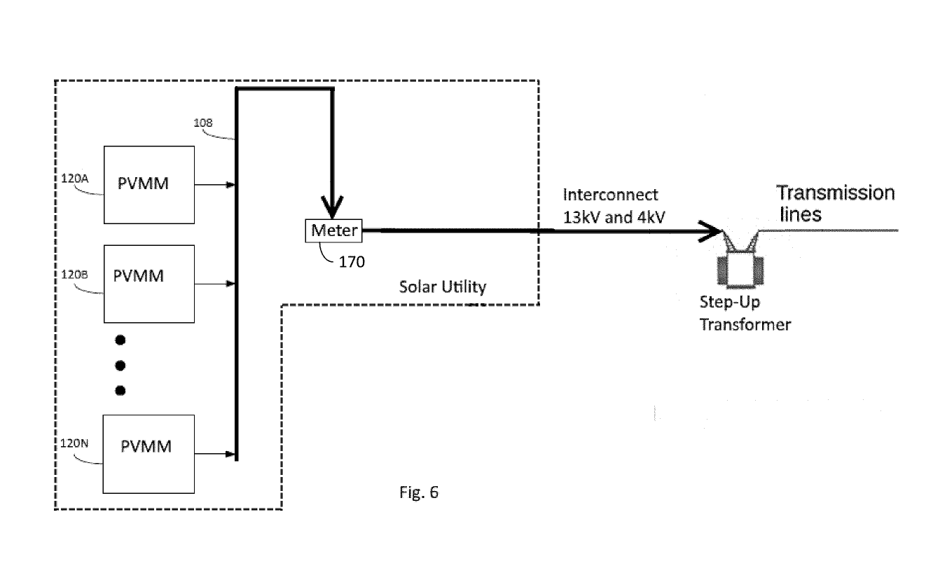

FIG. 6 illustrates a preferred embodiment wherein the scalable plurality of PVMMs 120 connected on AC bus 108, as illustrated in FIG. 3, is connected to and powers a grid-connected solar utility. The solar utility is grid-connected through a meter in this embodiment. This grid connection supplies a grid signal to inverters and causes inverters to oscillate in phase with the grid.

In the system of FIG. 6 the purposes of battery storage are understood to be, by one skilled in the art, to power the grid by PV power in sunny conditions, to power the grid by battery storage in dark conditions, but not to power the grid through grid-down events.

In the system of FIG. 6 the grid connection discrimination function of each of the scalable plurality of PVMMs 120 is switched off and none of the scalable plurality of PVMMs 120 is chosen as a master oscillator. Whereby, if there is a grid-down event, the PVMMs can therein respond instantly to the grid-down event and turn off, then instantly turn on when grid power is restored.

The scalable plurality of PVMMs 120 may be arrayed on the roof of a large building, on open land, on open water, or any combination thereof.

Each PVMM 120 includes an inverter 116, which is configured such that its AC output voltage and frequency matches the AC power standard of the grid.

The grid is low-impedance, enabling it to receives all the excess power generated by the scalable plurality of PVMMs 120 in sunny conditions and in dark conditions.

In sunny conditions, each of the scalable plurality of PVMMs charges its battery if grid load is low but powers the grid if grid load is high.

In dark conditions each of the scalable plurality of PVMMs powers the grid from its battery if grid load exists.

The grid-connected solar utility functionality of the preferred embodiment illustrated in FIG. 6 is a natural consequence of the operational steps illustrated in FIG. 2 and does not require any modification thereof.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

1. A photovoltaic (PV) electric system comprising:
a maximum power point tracking controller receiving an input from a PV panel;
a charge controller receiving an output from the maximum power point tracking controller via a direct current (DC) bus;
a battery coupled to the charge controller; and
an inverter coupled to the charge controller and the maximum power point tracking controller for generating an alternating current (AC) output, wherein the maximum power point tracking controller, the charge controller and inverter are disposed within the PV panel and the inverter is operative to receive an input from the charge controller.

2. The PV system of claim 1, wherein the battery is additionally disposed within the PV panel.

3. The PV system of claim 1 further comprising:
an AC bus having the inverter coupled thereto, the AC bus receiving the alternating current output therefrom such that the alternating current output is provided for electrical consumption.

4. The PV system of claim 3, wherein the AC bus connects a plurality of PV systems, the plurality of PV systems each having its own maximum power point tracking controller, charge controller and inverter disposed therein.

5. The PV system of claim 4, wherein the number of PV systems is scalable.

6. The PV system of claim 1 further comprising the maximum power point tracking controller regulating the power received from the PV panel.

7. The PV system of claim 6 further comprising reducing the power received from the PV panel in low-load conditions.

8. The PV system of claim 1 further comprising:
the charge controller regulating a charge of the battery.

9. The PV system of claim 8 further comprising charging the battery after passing power to the inverter.

10. The PV system of claim 1 further comprising the inverter providing the alternating current output.

11. The PV system of claim 10, wherein the system self-oscillates and provides the alternating current output in the absence of a grid signal.

12. The PV system of claim 10, wherein the system operates off-grid.

13. The PV system of claim 1 wherein the inverter is coupled to an electrical grid such that in the event of a grid-down event on the electrical grid, the charge controller provides power from the battery.

14. A photovoltaic (PV) system comprising:
a first PV panel including:
a first maximum power point tracking controller;
a first charge controller coupled to a first battery regulating energy storage and output from the first battery; and
a first inverter generating a first alternating current (AC) output based on a first charge controller output;
a second PV panel including:
a second maximum power point tracking controller;
a second charge controller coupled to a second battery regulating energy storage and output from the second battery; and
a second inverter generating a second AC output based on a second charge controller output; and
an AC bus, wherein the first PV panel and the second PV panel are both connected to the AC bus such that current generated from the first PV panel and the second PV panel is provided for electrical consumption.

15. The PV system of claim 14 further comprising:
the first maximum power point tracking controller receiving an input from the first PV panel and providing an output to the first charge controller receiving an output from the maximum power point tracking controller; and
the first inverter coupled to the first charge controller for generating the first AC output.

16. The PV system of claim 14 further comprising charging the first battery after passing power to the first inverter.

17. The PV system of claim 14 wherein the first inverter is coupled to an electrical grid such that in the event of a grid-down event, the charge controller provides power from the first battery.

18. The PV system of claim 14 further comprising:
a third PV panel including:
a third maximum power point tracking controller;
a third charge controller coupled to a third battery regulating energy storage and output from the third battery; and
a third inverter generating a third alternating current output based on a third charge controller output; and
wherein the third PV panel is connected to the AC bus such that current generated from the third PV panel is provided for electrical consumption.
